(19) United States
(12) Patent Application Publication
(10) Pub. No.: US 2018/0051915 A1
(43) Pub. Date: Feb. 22, 2018

(54) SUPPORT DEVICE FOR SOLAR MODULES, PHOTOVOLTAIC SETUP HAVING MULTIPLE SUPPORT DEVICES AND METHOD FOR SETTING UP SUCH A SUPPORT DEVICE

(71) Applicant: Cortec GmbH, Plattling (DE)

(72) Inventor: Johann Rainer, Moosthenning (DE)

(73) Assignee: Christian Rainer, Deggendorf (DE)

(21) Appl. No.: 15/556,566

(22) PCT Filed: Mar. 2, 2016
(86) PCT No.: PCT/EP2016/054374

§ 371 Date: Sep. 7, 2017

(30) Foreign Application Priority Data
Mar. 10, 2015 (DE) 20 2015 101 195.4
Jul. 27, 2015 (DE) 20 2015 103 930.1

(51) Int. Cl. F24J 2/54

(52) U.S. Cl. CPC F24J 2/541; Y02E 10/47; F24J 2002/5482

(57) ABSTRACT

The invention relates to a support device for pivot axes of solar modules which includes at least one first support leg and at least one second support leg, with each support leg configured for anchoring in a ground surface. A bridge mechanically couples the at least one first support leg to the at least one second support leg. A bearing is supported by the bridge to accommodate a pivot axis, with the at least one first support leg and the at least one second support leg detachably connected to the bridge.

### CROSS-REFERENCE TO RELATED APPLICATIONS

This application claims priority from German Patent Application No. 202015101195.4 filed Mar. 10, 2015 and German Patent Application No. 202015103930.1 filed Jul. 27, 2015, the disclosure of which are hereby incorporated herein by reference.

### FIELD OF THE INVENTION

The present invention relates to a support device formed from a plurality of parts.

### BACKGROUND OF THE INVENTION

Support devices formed from a plurality of parts and being intended for pivot axes of solar modules are already known from the prior art. So-called IPE beams, for example, are employed in practice. For installing such support beams in the ground, it is necessary to drill boreholes, which subsequently have to be backfilled and compacted before the beam is sunk into the ground in a force-impinged manner.

The assembly of photovoltaic installations using such beams is therefore very time-consuming, cost-intensive, and economically demanding.

### SUMMARY OF THE INVENTION

One object of the invention can therefore be seen in providing a support device, a photovoltaic installation, and also a method for erecting a support device intended for pivot axes of solar modules that in whole or at least in parts do not have the above-mentioned disadvantages.

The aforementioned object is fulfilled by a support device, a photovoltaic installation, and a method having the features of the claims 1, 12, and 13. Preferred embodiments of the invention are described in the dependent claims.

The invention relates to a support device for pivot axes of solar modules, the support device being formed from a plurality of parts. The support device has at least one first support leg and at least one second support leg, each of which are designed for anchoring in a ground surface. The at least one first support leg and/or the at least one second support leg can have a circular cross section in exemplary embodiments. The at least one first support leg and the at least one second support leg can be designed identically in terms of geometry and dimensions.

The support device moreover comprises a bridge, which mechanically couples the at least one first support leg to the at least one second support leg, and also comprises a bearing, which is designed to accommodate a pivot axis. The bearing in this connection is supported by the bridge. Furthermore, the at least one first support leg and the at least one second support leg are detachably connected to the bridge. It is possible, for example, that the at least one first support leg and the at least one second support leg are form-lockingly accommodated by the bridge.

In exemplary embodiments, the bridge can thus form an accommodation each for the at least one first support leg and the at least one second support leg, and it can be possible for the at least one first support leg and the at least one second support leg to be inserted in a form-locking or substantially form-locking manner into each particular accommodation.

It is moreover possible that the at least one first support leg and/or the at least one second support leg in each case form a thread at their free end region that is averted from the bridge. The at least one first support leg and/or the at least one second support leg can furthermore taper toward their particular free end region that is averted from the bridge, thereby facilitating sinking or anchoring the at least one first support leg and/or the at least one second support leg in a ground surface. The thread can expediently be designed for screwing the at least one first support leg and/or the at least one second support leg into a ground surface.

It is additionally possible that the support device comprises at least one clamp that is attachable at the bridge, by way of which clamp the at least one first support leg and/or the at least one second support leg can be fastened to the bridge in a force-impinged manner. The at least one clamp can be designed to form-lockingly accommodate the at least one first support leg and/or the at least one second support leg. In exemplary embodiments, at least one own clamp can be provided for the at least one first support leg and for the at least one second support leg each. The at least one first support leg and the at least one second support leg can then be fastened to the bridge in a force-impinged manner, each by way of their own clamp. It is also exemplary that the at least one clamp is pivotably mounted to the bridge and is fixed in a defined pivot position for the purpose of fastening the at least one first support leg and/or the at least one second support leg to the bridge in a forge-impinged manner.

In addition, at least one fastening means can be provided that is preferably designed as screw joint, by which fastening means the clamp intended for the force-impinged fastening of the at least one first support leg and/or of the at least one second support leg to the bridge can be held in a determined clamping position.

Embodiments in which the bearing can be detachably fastened to the bridge have also proven successful. Latch connections, snap connections, and/or clamp connections, for example, by means of which the bearing is detachably fastenable to the bridge, are also possible. The bearing can, in particular, be detachably fastened to the bridge by way of at least one screw joint.

It is furthermore possible that the bridge mechanically couples the at least one first support leg in relation to the at least one second support leg so that they are inclined toward each other. The longitudinal axes of the at least one first support leg and of the at least one second support leg can thus be oriented in a manner inclined toward each other. Embodiments have proven particularly successful in which the at least one first support leg and the at least one second support leg under inclined mechanical coupling with each other enclose an angle that is fixed at between 0° and 90° and preferentially at between 10° and 35°. It is furthermore possible that the angle is no greater than 25° and no smaller than 15°.

The bridge can additionally be designed as molded shell comprising at least two housing parts, which provide a corresponding accommodation for the form-locking connection of the at least one first support leg and/or of the at least one second support leg with the bridge.

The at least one first support leg and/or the at least one second support leg can furthermore be designed as hollow tube. In this connection, the at least one first support leg and/or the at least one second support leg can have a circular cross section, as mentioned above.

The invention further relates to a photovoltaic installation. The photovoltaic installation comprises a multitude of solar modules and at least one pivot axis to which the solar modules are fastened and also a plurality of support devices according to one or more embodiments of the preceding description. The at least one pivot axis is accommodated by way of the bearings of the plurality of support devices.

The invention furthermore relates to a method for erecting a support device intended for pivot axes of solar modules. Features that have been described above regarding the support device can likewise be provided in the method described below. It is also possible for features regarding the method as described below to be provided for the previously described support device as well, and they are therefore not redundantly mentioned herein.

According to the method, at least one first support leg is anchored in a ground surface. At least one second support leg is furthermore anchored in a ground surface. In a subsequent step, the at least one first support leg, which is anchored in the ground surface, is mechanically coupled with the at least one second support leg, which is anchored in the ground surface, by way of a bridge, which supports a bearing for accommodating a pivot axis and/or to which a bearing for accommodating a pivot axis is attached.

It can be provided in exemplary embodiments that the at least one first support leg and/or the at least one second support leg form a thread or, as the case may be, a screw thread in the region of a particular free end, by way of which particular thread the at least one first support leg and/or the at least one second support leg are screwed into the ground surface for anchoring.

It can moreover be provided that at least one clamp is fastened to the bridge for the mechanical coupling, as a result of which the at least one first support leg and/or the at least one second support leg is held in a force-impinged manner by way of the at least one clamp that is fastened to the bridge.

Embodiments have also proven successful in which the bearing for accommodating a pivot axis can be detachably attached to the bridge. Screw joints can be provided, for example, by means of which the bearing for accommodating a pivot axis is detachably attached to the bridge.

It is additionally possible that the bridge mechanically couples the at least one first support leg in relation to the at least one second support leg so that they are inclined toward each other. It is, for example, possible that the bridge mechanically couples the at least one first support leg in relation to the at least one second support leg so that they are inclined toward each other at an angle between 0° and 90° and preferentially between 10° and 35°. It is particularly possible that the bridge mechanically couples the at least one first support leg in relation to the at least one second support leg so that they are inclined toward each other at an angle that is no greater than 25° and no smaller than 15°.

In exemplary embodiments, the bridge can comprise at least two housing parts, with the housing parts being connected to each other for the mechanical coupling, and the housing parts in this context form-lockingly accommodating the at least one first support leg and/or the at least one second support leg.

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged in relation to other elements to facilitate an understanding of the invention.

### BRIEF DESCRIPTION OF DRAWINGS

FIG. 1 shows a horizontal tracker as already known from the prior art;

FIG. 2 shows a support beam of the horizontal tracker of FIG. 1;

FIG. 3 shows a schematic perspective view of a first embodiment of a support device according to the invention and also a first embodiment of a photovoltaic installation according to the invention;

FIG. 4 shows a support device of the embodiment of FIG. 3 with an illustration of further aspects;

FIG. 5 shows individual steps as can be provided in an exemplary embodiment of the method according to the invention;

FIG. 6 shows a schematic top view of an embodiment of a support device with an illustration of further aspects;

FIG. 7 shows a schematic view of a further embodiment of a support device according to the invention;

FIGS. 8a and 8b show the embodiment of a support device of FIG. 7 with an illustration of further aspects; and

FIG. 9 shows individual steps as can be provided in an exemplary embodiment of the method according to the invention.

### DESCRIPTION

The same or equivalent elements of the invention are in each case designated in the figures by identical reference characters. Furthermore and for the sake of clarity, only the reference characters relevant for describing the individual figures are provided. It should be understood that the detailed description and specific examples, while indicating preferred embodiments, are intended for purposes of illustration only and are not intended to limit the scope of the invention.

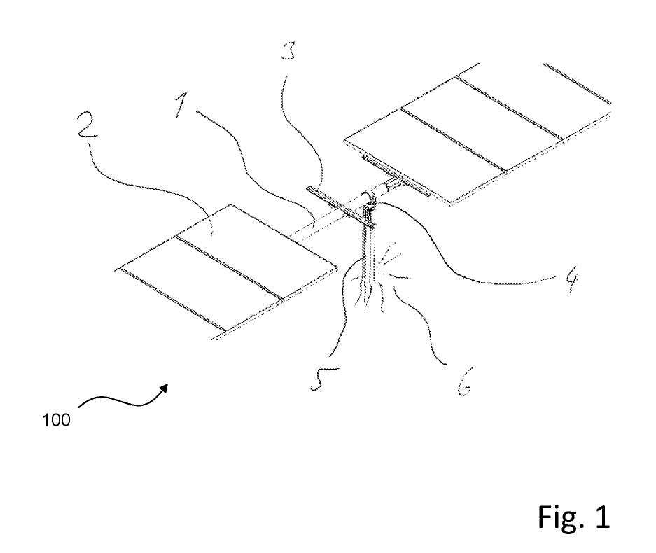

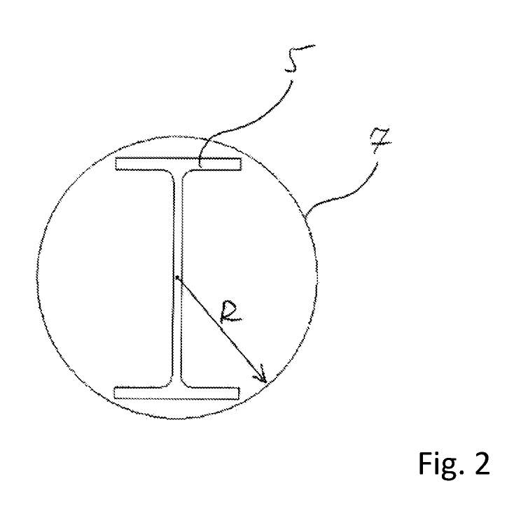

FIG. 1 shows a horizontal tracker 100 as already known from the prior art. A partial region of a pivot axis 1 being held by a bearing 4 is discernible. The bearing 4 is attached to a ground foundation, in the present instance to an IPE beam 5. Further discernible are solar modules 2, which are attached to the pivot axis 1 by means of module carrier 3. The embodiment shown in FIG. 2 relates to a common construction for trackers 100, where the illustrated bearing is multiply repeated (not illustrated here) along the entire length of the pivot axis 1. IPE beams 5, as illustrated here, or material-saving sheet metal profiles are driven into a ground surface 6 by way of ground foundations.

FIG. 2 shows a support beam 5 of the horizontal tracker 100 from FIG. 1. Also illustrated is a minimum circumscribed circle 7 for the IPE beam 5. If ground conditions do not allow the IPE beams 5 to be driven directly into a ground surface 6, the methods as known from the prior art require corresponding boreholes with a minimum circumscribed circle radius R to be produced first. The boreholes are subsequently backfilled and compacted. The IPE beams 5 are then driven into the backfilled and compacted boreholes. This involves considerable additional time-consuming and financial efforts for installation.

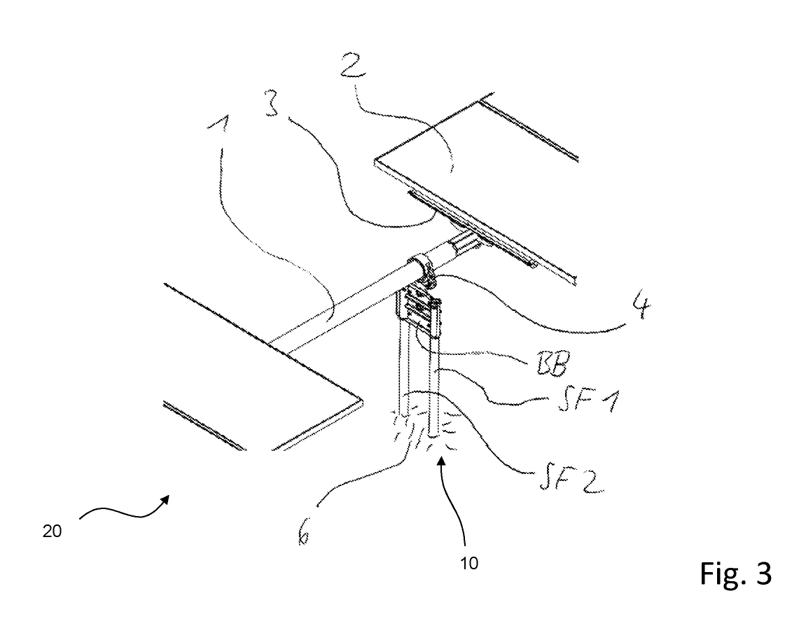

FIG. 3 shows a schematic perspective view of a first embodiment of a support device 10 according to the invention and also a first embodiment of a photovoltaic installation 20 according to the invention.

The photovoltaic installation 20 comprises a multitude of solar modules 2, a pivot axis 1, and also a plurality of module carriers 3 by way of which the solar modules 2 are attached to the pivot axis 1. The photovoltaic installation 20 moreover has a plurality of support devices 10, one of which is discernible in FIG. 3. The pivot axis 1 is pivotably accommodated by way of the bearings 4 of the plurality of support devices 10.

The support device 10 discernible in FIG. 3 comprises a first support leg SF1 and a second support leg SF2, each of which are anchored in a ground surface 6. In the embodiment of FIG. 3, the first support leg SF1 and the second support leg SF2 are oriented parallel to each other. Further discernible is a bridge BB, which mechanically couples the first support leg SF1 and the second support leg SF2 to each other while maintaining them in their relative orientation to each other. The pivot axis 1 is accommodated by way of the bearing 4, as mentioned above. The bearing 4 is furthermore supported by the bridge BB. Both the first support leg SF1 and the second support leg SF2 are detachably connected to the bridge BB or, as the case may be, detachably fastened to the bridge BB. The bearing 4 is also detachably held to the bridge BB, that is to say, it can be removed from the bridge BB.

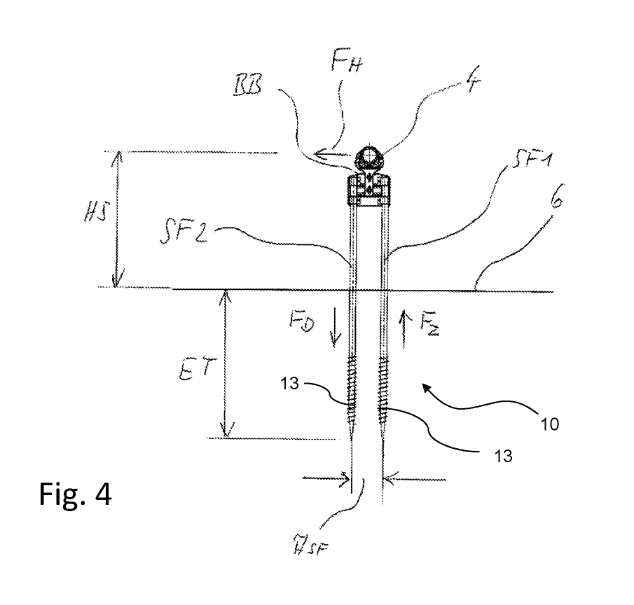

FIG. 4 shows a support device 10 of the embodiment from FIG. 3 with an illustration of further aspects.

Due to the construction of single-axis horizontal trackers, a main load direction FH acts horizontally on the pivot bearing 4 at a height HS that the pivot axis 1 has in relation to the ground surface 6. In the support device 10, the bridge BB, which mechanically couples the first and the second support leg SF1 and SF2, converts these loads to compressive forces FD and tensile forces FZ, which the first support leg SF1 and the second support leg SF2 can introduce into the ground surface 6 spaced apart by a distance ASF. An embedment depth ET of the first support leg SF1 and the second support leg SF2 can be adapted to the ground conditions. For the purpose of sinking or, as the case may be, screwing the first support leg SF1 and the second support leg SF2 into the ground surface 6, the first support leg SF1 and the second support leg SF2 each form a thread 13 at their particular free end region that is averted from the bridge BB. The first support leg SF1 and the second support leg SF2 are oriented parallel to each other in the embodiment from FIG. 4, or rather, they are mechanically coupled parallely oriented to each other by way of the bridge BB in the embodiment from FIG. 4.

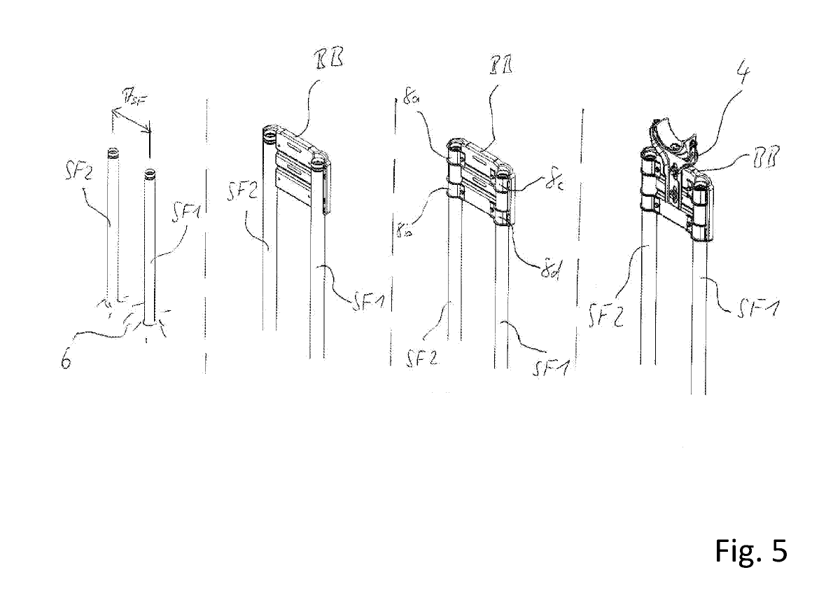

FIG. 5 shows individual steps as can be provided in an exemplary embodiment of the method according to the invention.

Step 1: A first support leg SF1 and a second support leg SF2 are sunk into a ground surface 6 or, as the case may be, anchored in a ground surface 6, with a defined relative distance ASF to each other. After having been anchored in the ground surface 6 or, as the case may be, sunk into the ground surface 6, the support legs SF1 and SF2 are oriented parallel to each other and project from the ground surface 6 by an approximately same amount of their particular longitudinal extension. Each of the support legs SF1 and SF2 has a thread 13 (cf. FIG. 4). For the purpose of anchoring in the ground surface 6 or, as the case may be, sinking into the ground surface 6, the first support leg SF1 and the second support leg SF2 are screwed into the ground surface 6.

Steps 2 and 3: The first support leg SF1, which is anchored in the ground surface, 6 and the second support leg SF2, which is anchored in the ground surface 6, are mechanically coupled to each other by way of a bridge BB. The bridge BB holds the first support leg SF1 that is anchored in the ground surface 6 in relation to the second support leg SF2 that is anchored in the ground surface 6 so that they remain in their relative position to each other. For the mechanical coupling, clamps 8a to 8d are provided by way of which the first support leg SF1 and the second support leg SF2 are fastened to the bridge BB in a force-impinged manner.

Step 4: A bearing 4 is attached to the bridge BB. Step 4 is carried out in temporal succession to the steps 1 to 3. The bearing 4 can be attached to the bridge BB by way of screw joints, for example.

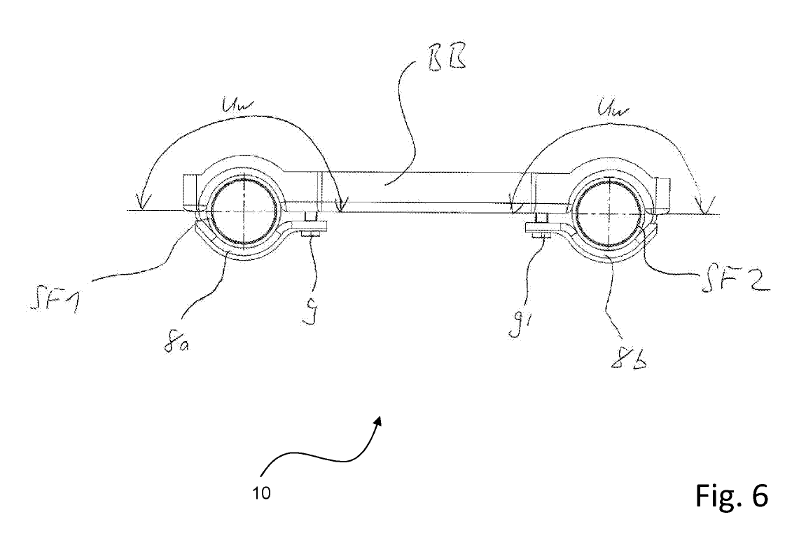

FIG. 6 shows a schematic top view of an embodiment of a support device 10 with an illustration of further aspects. The first support leg SF1 and the second support leg SF2 are each designed as hollow tubes, and they have a circular cross section. It is discernible from FIG. 6 that a lateral area of the first support leg SF1 and a lateral area of the second support leg SF2 abut on the bridge BB by more than 90° or, as the case may be, at least approximately 180° along their circumference. The first support leg SF1 and the second support leg SF2 are thus form-lockingly accommodated by way of the bridge BB. The first support leg SF1 and the second support leg SF2 are moreover held to the bridge BB by means of the clamps 8a to 8d. Due to the form-locking accommodation of the first support leg SF1 and of the second support leg SF2 by means of the bridge BB, there is only minor stress on the clamps 8a to 8d and also on the screw joints 9 and 9′ provided for fastening the clamps 8a to 8d to the bridge BB.

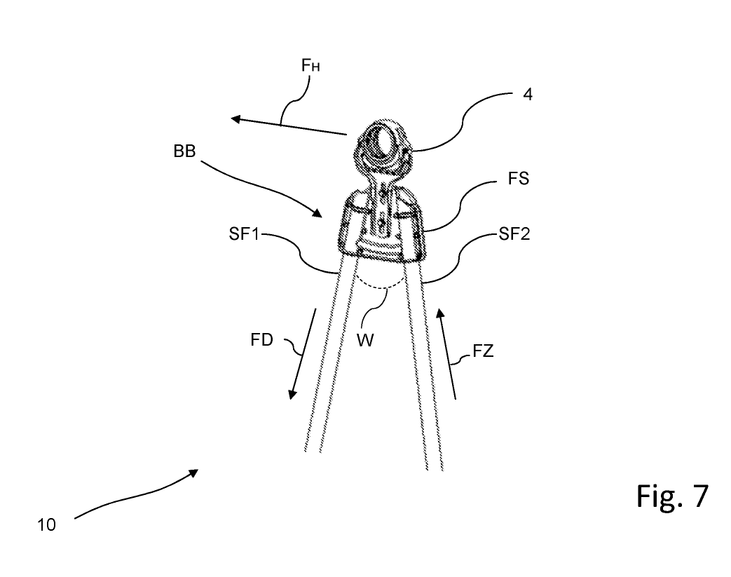

FIG. 7 shows a schematic view of a further embodiment of a support device 10 according to the invention. The first support leg SF1 and the second support leg SF2 are mechanically coupled to each other by the bridge BB such that the first support leg SF1 and the second support leg SF2 together with the bridge BB form an A shape. In this context, the first support leg SF1, or rather a longitudinal axis of the first support leg SF1, and the second support leg SF2, or rather a longitudinal axis of the second support leg SF2, together enclose an angle W that is formed to be no smaller than 15° and no greater than 25°.

In the exemplary embodiment of FIG. 7, the bridge BB comprises a two-part molded shell FS, which is formed from molded shell halves that are designed correspondingly to each other, and by means of which molded shell FS the first support leg SF1 and the second support leg SF2 can be form-lockingly accommodated.

A bearing 4 for a non-illustrated pivot axis 1 is disposed above the molded shell FS. Since considerable lateral forces occur in possible applications of the support device 10 according to the invention, it is, for example, possible for the main load direction FH illustrated in FIG. 7 to result therefrom. The lateral forces introduced to the molded shell FS connecting the support legs SF1 and SF2 can be converted to tensile forces FZ and compressive forces FD by means of the support legs SF1 and SF2 standing in A shape so that the result is a great stability of the entire support device 10.

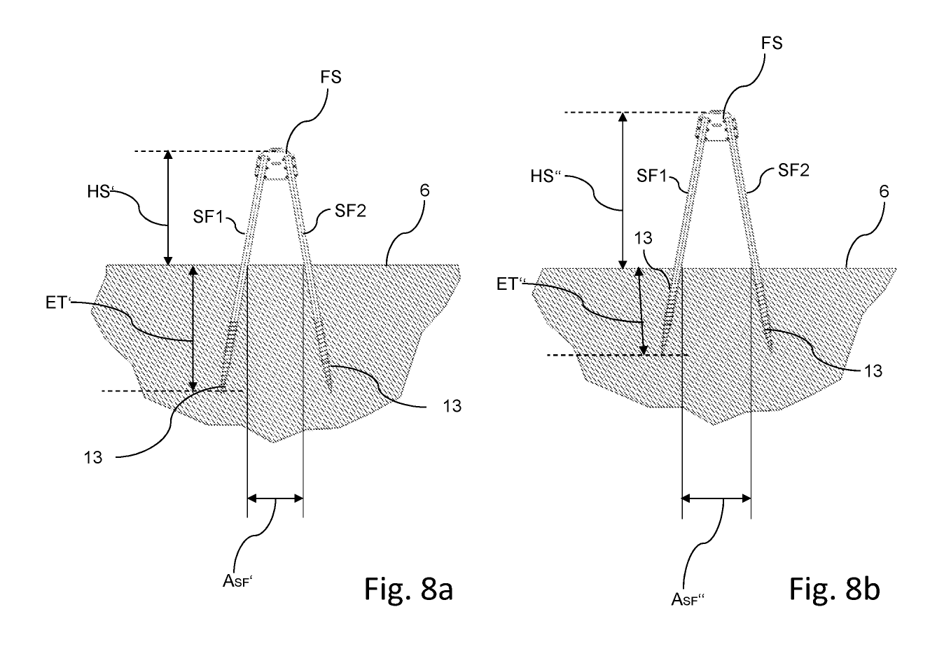

FIG. 8 shows the embodiment of a support device 10 from FIG. 7 with an illustration of further aspects. The FIGS. 8a and 8b, in particular, show different possibilities for erecting an embodiment of a support device 10 according to the invention on a ground surface 6 or, as the case may be, for sinking it into a ground surface 6. The first support leg SF1 and the second support leg SF2 in FIG. 8a have a considerable embedment depth ET′, which can be necessary in order to stably bear a photovoltaic installation 20 (cf. FIG. 3) in certain ground conditions according to FIG. 8a, for example. The great embedment depth ET′ of the support legs SF1 and SF2 in the ground surface 6 results in a lower height of the pivot axis HS' and also in a smaller base ASF′ of the support legs SF1 and SF2 in the region of the ground surface 6. If, as shown in FIG. 8b, less embedment depth ET″ in the ground surface 6 is sufficient, the pivot axis 1 will have a greater height HS″. In comparison to FIG. 8a, this results in a greater base ASF″ of the support legs SF1 and SF2 in the region of the ground surface 6. A technical effect of the support device 10 according to the embodiment from FIGS. 8a and 8b therefore is that, with the distance of the pivot axis 1 to the ground increasing from HS' to HS″, the width of the base also increases from ASF′ to ASF″. With a variable embedment depth of the support legs SF1 and SF2, however, changes in terms of statics are rarely necessary. The static conditions of the support device 10 remain approximately unchanged in this context, whereas the static limits of regular profiles, such as IPE profiles, are readily exceeded.

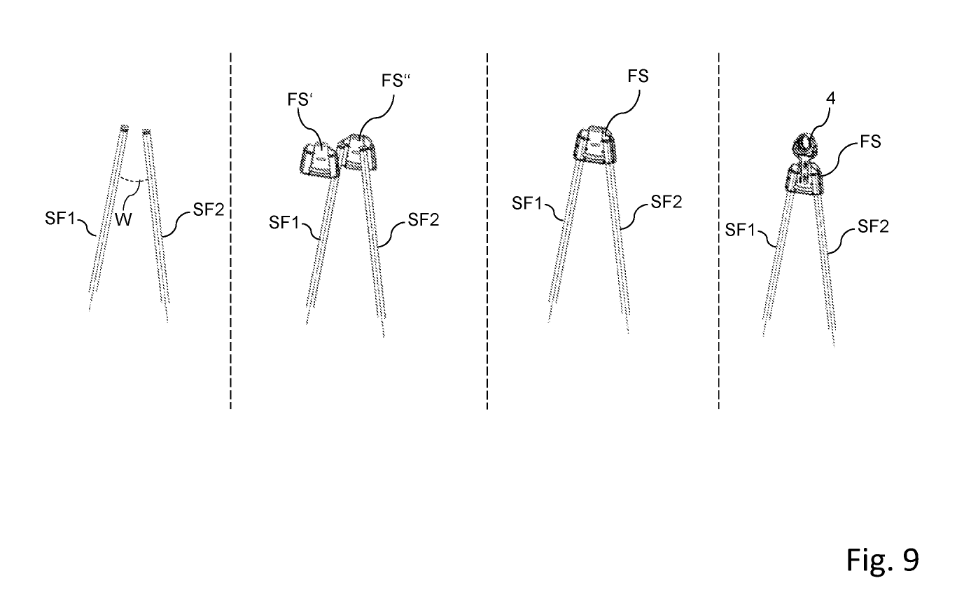

FIG. 9 shows individual steps as can be provided in an exemplary embodiment of the method according to the invention. In particular, FIG. 9 shows a method for erecting an embodiment of a support device 10 according to FIG. 7, which support device 10 is intended for pivot axes 1 of solar modules 2.

Step 1′: A first support leg SF1 and a second support leg SF2 are screwed into a ground surface 6 so as to together enclose an angle W of approximately 20°. For this purpose, the first support leg SF1 and the second support leg each form a thread 13 (cf. FIG. 8).

Step 2′: The two molded shell halves FS' and FS″ are mounted for connecting the screw foundations SF1 and SF2.

Step 3′: The two mutually corresponding molded shell halves FS' and FS″ of the bridge BB are screwed, riveted, or otherwise connected to each other such that the first support leg SF1 and the second support leg SF2 are mechanically coupled to each other by way of the bridge BB or, as the case may be, by way of the two mutually corresponding molded shell halves FS' and FS″.

Step 4′: The bearing 4 is attached to the bridge BB or, as the case may be, to the two mutually corresponding molded shell halves FS' and FS″.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A support device for pivot axes of solar modules, the support device comprising:
at least one first support leg and at least one second support leg, wherein each support leg is configured to anchor in a ground surface;
a bridge mechanically coupling the at least one first support leg to the at least one second support leg; and
a bearing designed to accommodate a pivot axis,
wherein the bearing is supported by the bridge and wherein the at least one first support leg and the at least one second support leg are detachably connected at one end to the bridge with the opposite, unconnected end of each support leg free.

2. The support device as recited in claim 1 wherein the at least one first support leg and the at least one second support leg are threaded at their respective free end.

3. The support device as recited in claim 1, further comprising at least one clamp attached to the bridge, wherein the at least one first support leg and the at least one second support leg are fastened to the bridge by the clamp.

4. The support device as recited in claim 3, wherein the at least one clamp comprises a screw joint operable to secure the clamp in a determined clamping position to secure the at least one first support leg and the at least one second support leg.

5. The support device as recited in claim 1 wherein the bearing is detachably fastened to the bridge.

6. The support device as recited in claim 5, wherein the bearing is detachably fastened to the bridge by at least one screw joint.

7. The support device as recited in claim 1, wherein the bridge mechanically couples the at least one first support leg in relation to the at least one second support leg such that they are inclined toward each other at an angle between 0° and 90°.

8. The support device as recited in claim 7 in which the at least one first support leg and the at least one second support leg are inclined towards each other at an angle between 10° and 35°.

9. The support device as recited in claim 8 wherein the at least one first support leg and the at least one second support leg are inclined towards each other at an angle between 15° and 25°.

10. The support device as recited in claim 1, wherein the bridge is a molded shell comprising at least two housing parts which provide accommodation for the connection of the at least one first support leg and the at least one second support leg with the molded shell.

11. The support device as recited in claim 1, wherein the at least one first support leg and the at least one second support leg are hollow tubes.

12. A photovoltaic installation comprising a plurality of solar modules, at least one pivot axis to which the plurality of solar modules are fastened, and a plurality of support devices as set forth in claim 1.

13. A method for erecting a support device for pivot axes of solar modules, the method comprising the steps of:
anchoring at least one first support leg in a ground surface,
anchoring at least one second support leg in the ground surface,
mechanically coupling the at least one first support leg with the at least one second support leg via a bridge, wherein the bridge supports a bearing for accommodating a pivot axis.

14. The method as recited in claim 13 in which the at least one first support leg and the at least one second support leg are threaded in the region of their respective uncoupled free ends, such that a threaded portion of the at least one first support leg and a threaded portion of the at least one second support leg are screwed into the ground surface for anchoring.

15. The method as recited in claim 13 wherein at least one clamp is fastened to the bridge such that the at least one first support leg and the at least one second support leg are held in a force-impinged manner via the at least one clamp.

16. The method as recited in claim 13, wherein the bearing for accommodating a pivot axis is detachably attached to the bridge.

17. The method as recited in claim 13, wherein the bridge mechanically couples the at least one first support leg in relation to the at least one second support leg such that they are inclined toward each other.

18. The method as recited in claim 17 wherein the bridge mechanically couples the at least one first support leg in relation to the at least one second support leg such that they are inclined toward each other at an angle between 10° and 35°.

19. The method as recited in claim 17 wherein the bridge mechanically couples the at least one first support leg in relation to the at least one second support leg such that they are inclined toward each other at an angle that is between 15° and 25°.

20. The method as recited in claim 13, wherein the bridge comprises at least two housing parts connected to each other to form a mechanical coupling, wherein the housing parts form-lockingly accommodate the at least one first support leg and the at least one second support leg.
